(19) United States
(12) Patent Application Publication
(10) Pub. No.: US 2022/0315698 A1
(43) Pub. Date: Oct. 6, 2022

(54) METHOD FOR PRODUCING POLYETHER CARBONATE POLYOLS

(71) Applicants: Covestro Deutschland AG, Leverkusen (DE); Covestro Intellectual Property GmbH & Co. KG, Leverkusen (DE)

(72) Inventors: Joerg Hofman, Krefeld (DE); Kai Laemmerhold, Odenthal (DE); Persefoni Hilken, Leverkusen (DE); Nicole Welsch, Rösrath (DE); Hartmut Nefzger, Pulheim (DE)

(21) Appl. No.: 17/618,054

(22) PCT Filed: Jul. 24, 2020
(86) PCT No.: PCT/EP2020/070902

§ 371 Date: Dec. 10, 2021

(30) Foreign Application Priority Data
Jul. 31, 2019 (EP) 19189265.2
Feb. 13, 2020 (EP) 20157274.0

(51) Int. Cl. C08G 65/26; C08G 64/34

(52) U.S. Cl. CPC C08G 65/2663; C08G 65/2609; C08G 64/34

(57) ABSTRACT

A method for producing polyether carbonate polyols via the following steps: (i) accumulating alkylene oxide and carbon dioxide on a H-functional starter substance in the presence of a double metal cyanide catalyst or a metal complex catalyst based on the metals zinc and/or cobalt, wherein a reaction mixture containing the polyether carbonate polyol is obtained; and (ii) adding at least one component K to the reaction mixture containing the polyether carbonate polyol, wherein a buffer system suitable for buffering a pH value in the region of pH 3.0 to 9.0 is used as component K, wherein the component K is free from compounds containing P—OH— groups.

### CROSS REFERENCE TO RELATED APPLICATIONS

This application is a U.S. national stage application, filed under 35 U.S.C. § 371, of International Application No. PCT/EP2020/070902, which was filed on Jul. 24, 2020, and which claims priority to European Patent Application No. 20157274.0 which was filed on Feb. 13, 2020, and to European Patent Application No. 19189265.2 which was filed on Jul. 31, 2019. The contents of each are hereby incorporated by reference into this specification.

### FIELD

The present invention relates to a process for preparing polyether carbonate polyols by catalytic copolymerization of carbon dioxide (CO₂) with alkylene oxide in the presence of one or more H-functional starter substances.

### BACKGROUND

The preparation of polyether carbonate polyols by catalytic reaction of alkylene oxides (epoxides) and carbon dioxide in the presence of H-functional starter substances (“starters”) has been the subject of intensive study for more than 40 years (e.g. Inoue et al, Copolymerization of Carbon Dioxide and Epoxide with Organometallic Compounds; Die Makromolekulare Chemie [Macromolecular Chemistry] 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are each integers, and where the product shown here in scheme (I) for the polyether carbonate polyol should merely be understood in such a way that blocks having the structure shown may in principle be present in the polyether carbonate polyol obtained, but the sequence, number and length of the blocks and the OH functionality of the starter may vary and is not restricted to the polyether carbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R=CH₃, propylene carbonate).

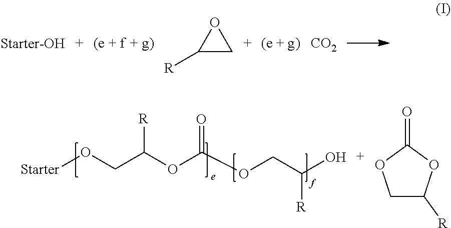

EP-A 2 530 101 discloses a process for preparing polyether carbonate polyols by reaction of at least one alkylene oxide and carbon dioxide onto an H-functional starter substance in the presence of a DMC catalyst. However, EP-A 2 530 101 does not disclose how polyether carbonate polyols can be stabilized toward thermal stress in order to achieve a very low content of cyclic carbonate after thermal stress.

EP-A 3 027 673 discloses a process for preparing polyether carbonate polyols by addition reaction of alkylene oxide and carbon dioxide onto an H-functional starter substance in the presence of a DMC catalyst. The obtained polyether carbonate polyol is admixed with a compound containing a phosphorus-oxygen bond or a compound capable of forming one or more P—O bonds by reaction with OH-functional compounds. Adding such a compound results in a reduced formation of dimethyl dioxane when the polyether carbonate polyols are subjected to thermal stress. EP-A 3 027 673 provides no information on the reduction of cyclic carbonates.

### SUMMARY

It was an object of the present invention to provide a process for preparing polyether carbonate polyols, wherein the process affords a product having the lowest possible content of cyclic carbonate after thermal stress.

It has surprisingly been found that polyether carbonate polyols having a relatively low content of cyclic carbonate relative to the prior art after thermal stress are obtained by a process for preparing polyether carbonate polyols,
(i) addition reaction of alkylene oxide and carbon dioxide onto an H-functional starter substance in the presence of a double metal cyanide catalyst or a metal complex catalyst based on the metals zinc and/or cobalt to obtain a reaction mixture containing the polyether carbonate polyol,
(ii) addition of at least one component K to the reaction mixture containing the polyether carbonate polyol, characterized in that as component K a buffer system suitable for buffering a pH in the range from pH 3.0 to PH 9.0 is employed, wherein component K is free from compounds containing P—OH groups.

The thus obtained polyether carbonate polyols moreover have a relatively low content of cyclic carbonate relative to the prior art after thermal workup. The present invention thus also provides a process, wherein
(iii) the content of volatile constituents in the reaction mixture from step (ii) is thermally reduced at a temperature of 80° C. to 200° C.

### DETAILED DESCRIPTION

It is characteristic of the polyether carbonate polyols prepared in accordance with the invention that they also contain ether groups between the carbonate groups. In the case of formula (Ia) this means that the ratio of e/f is preferably from 2:1 to 1:20, more preferably from 1.5:1 to 1:10.

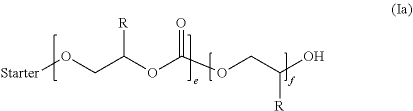

Thermal stress arising during a process for preparing polyether carbonate polyols typically occurs during purification by thermal processes such as thin film evaporation for example.

There may optionally follow as step (iv) a further addition of at least one component K to bring the obtained product from step (iii) to a desired content of one or more particular components K.

By way of example component K is added in step (ii) and optionally in step (iv) in an amount of in each case 5 ppm to 2000 ppm, preferably 10 ppm to 1000 ppm, more preferably 30 to 500 ppm.

Component K

According to the invention as component K a buffer system suitable for buffering a pH in the range from pH 3.0 to PH 9.0 is employed, wherein component K is free from compounds containing P—OH groups. Buffering a pH in the context of the invention is to be understood as meaning that upon addition of up to 5 mol % of hydroxide ions or hydronium ions based on the sum of the amount of substance of the acid and its conjugate base or of the base and its conjugate acid the change in pH is not more than ±0.1. It is preferable when the buffer systems of component K contain no phosphorus-oxygen bond or a compound of phosphorus capable of forming one or more P—O bonds by reaction with OH-functional compounds.

Buffer systems are common knowledge and are described for example in Walter R. Carmondy, Journal of Chemical Education, Volume 38, Number 11, 559, 1961. Buffer systems consist of acids and their conjugate base or bases and their conjugate acid. The buffer system may already be added as component K as a mixture of the acid and its conjugate base or the base and its conjugate acid, for example as a mixture of acid and an alkali metal salt of the acid or in an aqueous solution. It is likewise possible for the conjugate base or acid to be formed only after addition of the component K to the reaction mixture. It is preferable to employ a buffer system which is suitable for buffering a pH in the range from pH 3.0 to pH 7.5, more preferably from pH 3.5 to pH 6.5, especially preferably from pH 4.0 to pH 6.0.

Examples of suitable buffer systems are mixtures of carboxylic acids and their alkali metal salts, such as malic acid/alkali metal salt of malic acid, acetic acid/Na acetate, citric acid/Na citrate, aqueous solutions of alkali metal salts of carboxylic acids such as potassium hydrogen citrate, potassium hydrogen tartrate or potassium hydrogen phthalate, BisTris (bis(2-hydroxyethyl)amino-tris(hydroxymethyl)methane), PIPES (piperazine-N,N′-bis(2-ethanesulfonic acid) or Good's buffers such as MES (2-(N-morpholino)ethanesulfonic acid) and HEPPS (4-(2-hydroxyethyl)-piperazine-1-propanesulfonic acid).

Step (i):

The addition reaction of alkylene oxide and carbon dioxide in the presence of a DMC catalyst or a metal complex catalyst based on the metals zinc and/or cobalt onto an H-functional starter substance (“copolymerization”) affords a reaction mixture containing the polyether carbonate polyol and optionally cyclic carbonate (cf. scheme (I), for example addition reaction of propylene oxide (R=CH₃) thus affords propylene carbonate).

For example, the process of step (i) is characterized in that
(α) the H-functional starter substance or a mixture of at least two H-functional starter substances or a suspension medium is initially charged and optionally water and/or other volatile compounds are removed by elevated temperature and/or reduced pressure (“drying”), wherein the catalyst is added to the H-functional starter substance or to the mixture of at least two H-functional starter substances or the suspension medium before or after the drying,
(β) optionally for activation of the DMC catalyst a subamount (based on the total amount of alkylene oxides employed in the activation and copolymerization) of alkylene oxide is added to the mixture resulting from step (α), wherein this addition of a subamount of alkylene oxide may optionally be carried out in the presence of CO₂ and wherein the temperature spike (“hotspot”) occurring on account of the subsequent exothermic chemical reaction and/or a pressure drop in the reactor is then awaited in each case and wherein step (β) for activation may also be carried out two or more times,
(γ) alkylene oxide, carbon dioxide and optionally an H-functional starter substance are added to the mixture resulting from step (β),

wherein at least one H-functional starter substance is added in at least one of steps (α) or (γ).

Any optionally employed suspension media contain no H-functional groups. Suitable suspension media include all polar aprotic, weakly polar aprotic and non-polar aprotic solvents, none of which contain any H-functional groups. A mixture of two or more of these suspension media may also be used as suspension medium. Examples of polar aprotic suspension media that may be mentioned here include: 4-methyl-2-oxo-1,3-dioxolane (also referred to hereinbelow as cyclic propylene carbonate or cPC), 1,3-dioxolan-2-one (also referred to hereinbelow as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of nonpolar and weakly polar aprotic suspension media includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferably employed as suspension media are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

The process according to the invention may generally employ alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides employed are preferably 1-butene oxide, ethylene oxide and/or propylene oxide, in particular propylene oxide.

Suitable H-functional starter substances (“starters”) used may be compounds having alkoxylation-active hydrogen atoms and having a molar mass of 18 to 4500 g/mol, preferably of 62 to 500 g/mol and more preferably of 62 to 182 g/mol. The ability to use a starter having a low molar mass is a distinct advantage over the use of oligomeric starters prepared by means of a preceding oxyalkylation. In particular an economic viability is achieved which is made possible by the omission of a separate oxyalkylation process.

Alkoxylation-active groups having active H atoms are, for example, —OH, —NH₂ (primary amines), —NH— (secondary amines), —SH and —CO₂H, preferably —OH and —NH₂, more preferably —OH. H-functional starter substances used are, for example, one or more compounds selected from the group consisting of mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. Examples of C1-C24 alkyl fatty acid esters containing on average at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®TM products (from USSC Co.).

Mono-H-functional starter substances that may be employed include alcohols, amines, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (for example 3-methyl-1,5-pentanediol), 1,6-hexanediol, 1,8-octanediol, 1,10-decanediol, 1,12-dodecanediol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and all the modification products of these aforementioned alcohols with different amounts of ε-caprolactone.

The H-functional starter substances may also be selected from the substance class of the polyether polyols having a molecular weight Mₙ in the range from 18 to 4500 g/mol and a functionality of 2 to 3. Preference is given to polyether polyols formed from repeating ethylene oxide and propylene oxide units, preferably having a proportion of propylene oxide units of 35% to 100%, more preferably having a proportion of propylene oxide units of 50% to 100%. These may be random copolymers, gradient copolymers, alternating copolymers or block copolymers of ethylene oxide and propylene oxide.

The H-functional starter substances may also be selected from the substance class of the polyester polyols. At least bifunctional polyesters are used as the polyester polyols. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyether carbonate polyols.

In addition, H-functional starter substances used may be polycarbonate diols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, polyether carbonate polyols may be used as H-functional starter substances. Use is made in particular of polyether carbonate polyols which are obtainable by process step (i) according to the invention described here. To this end these polyether carbonate polyols used as H-functional starter substances are produced beforehand in a separate reaction step.

The H-functional starter substances generally have a functionality (i.e. the number of polymerization-active H atoms per molecule) of 1 to 8, preferably of 2 or 3. The H-functional starter substances are used either individually or as a mixture of at least two H-functional starter substances.

It is particularly preferable when the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol and polyether polyols having a molecular weight Mₙ in the range from 150 to 4500 g/mol and a functionality of 2 to 3.

The polyether carbonate polyols are prepared by catalytic addition reaction of carbon dioxide and alkylene oxides onto H-functional starter substances. In the context of the invention “H-functional” is understood to mean the number of alkoxylation-active hydrogen atoms per molecule of the starter substance.

Step (α):

In step (α) it is preferable when a suspension medium containing no H-functional groups is initially charged in the reactor, optionally together with catalyst, and thereby no H-functional starter substance is initially charged in the reactor. Alternatively, it is also possible in step (α) to initially charge in the reactor a suspension medium containing no H-functional groups and additionally a subamount of the H-functional starter substance and optionally catalyst or it is also possible in step (α) to initially charge in the reactor a subamount of the H-functional starter substance and optionally catalyst. It is moreover also possible in step (α) to initially charge in the reactor the total amount of the H-functional starter substance and optionally catalyst.

The catalyst is preferably used in an amount such that the content of catalyst in the reaction product resulting from step (i) is 10 to 10 000 ppm, more preferably 20 to 5000 ppm and most preferably 50 to 500 ppm.

In a preferred embodiment, inert gas (for example argon or nitrogen), an inert gas/carbon dioxide mixture or carbon dioxide is introduced into the resulting mixture of catalyst with suspension medium and/or H-functional starter substance at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of catalyst and suspension medium and/or H-functional starter substance is contacted at a temperature of 90° C. to 150° C., more preferably of 100° C. to 140° C., at least once, preferably three times, with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is in each case reduced to about 1 bar (absolute).

The catalyst may be added for example in solid form or as a suspension in a suspension medium or as a suspension in an H-functional starter substance.

In a further preferred embodiment, in step (α)
(α-I) suspension medium and/or a subamount or the total amount of H-functional starting substance is initially charged and
(α-II) the temperature of the suspension medium and/or the H-functional starter substance is brought to 50° C. to 200° C., preferably 80° C. to 160° C., more preferably 100° C. to 140° C., and/or the pressure in the reactor is reduced to less than 500 mbar, preferably 5 mbar to 100 mbar, wherein an inert gas stream (for example of argon or nitrogen), an inert gas/carbon dioxide stream or a carbon dioxide stream is optionally passed through the reactor,

wherein the catalyst is added to the suspension medium and/or to the H-functional starter substance in step (α-I) or immediately thereafter in step (α-II) and wherein the suspension medium contains no H-functional groups.

Step (β):

Step (β) serves to activate the DMC catalyst. This step may optionally be performed under an inert gas atmosphere, under an atmosphere of inert gas/carbon dioxide mixture or under a carbon dioxide atmosphere. Activation in the context of this invention refers to a step in which a subamount of the alkylene oxide is added to the DMC catalyst suspension at temperatures of 90° C. to 150° C. and then the addition of the alkylene oxide is stopped, with observation of evolution of heat caused by a subsequent exothermic chemical reaction, which can lead to a temperature peak (“hotspot”), and of a pressure drop in the reactor caused by the conversion of alkylene oxide and possibly CO₂. The process step of activation is the period from addition of the subamount of alkylene oxide, optionally in the presence of CO₂, to the DMC catalyst until evolution of heat occurs. Optionally, the subamount of alkylene oxide may be added to the DMC catalyst in a plurality of individual steps, optionally in the presence of CO₂, and the addition of the alkylene oxide interrupted in each case. In this case the process step of activation comprises the period from addition of the first subamount of alkylene oxide, optionally in the presence of CO₂, to the DMC catalyst until evolution of heat occurs after addition of the last subamount of alkylene oxide. In general, the activation step may be preceded by a step for drying the DMC catalyst and optionally the H-functional starter substance at elevated temperature and/or reduced pressure, optionally with passage of an inert gas through the reaction mixture.

Metered addition of one or more alkylene oxides (and optionally of the carbon dioxide) may in principle be effected in different ways. The metered addition can be commenced from the vacuum or at a previously chosen supply pressure. The supply pressure is preferably established by introducing an inert gas (for example nitrogen or argon) or carbon dioxide, wherein the (absolute) pressure is 5 mbar to 100 bar, by preference 10 mbar to 50 bar and preferably 20 mbar to 50 bar.

In a preferred embodiment, the amount of one or more alkylene oxides used in the activation in step (β) is 0.1% to 25.0% by weight, preferably 1.0% to 20.0% by weight, more preferably 2.0% to 16.0% by weight (based on the amount of suspension medium and/or H-functional starter substance used in step (α)). The alkylene oxide may be added in one step or portionwise in two or more subamounts. It is preferable when after addition of a subamount of alkylene oxide the addition of the alkylene oxide is interrupted until the evolution of heat occurs and the next subamount of alkylene oxide is added only then. Preference is also given to a two-stage activation (step β), wherein
(β1) in a first activation stage addition of a first subamount of alkylene oxide is effected under an inert gas atmosphere or carbon dioxide atmosphere and
(β2) in a second activation stage a second subamount of alkylene oxide is added under a carbon dioxide atmosphere.

Step (γ):

For the process according to the invention, it has been found that step (γ) is performed advantageously at 50° C. to 150° C., preferably at 60° C. to 145° C., more preferably at 70° C. to 140° C. and most preferably at 90° C. to 130° C. Below 50° C., the reaction to form a polyether carbonate polyol proceeds only very slowly. At temperatures above 150° C., the amount of unwanted by-products rises significantly.

The metered addition of one or more alkylene oxides and the carbon dioxide can be effected simultaneously, alternately or sequentially, wherein the total amount of carbon dioxide can be added all at once or in the form of a metered addition over the reaction time. It is possible, during the addition of the alkylene oxide, to increase or lower the CO₂ pressure gradually or stepwise or to leave it constant. The total pressure is preferably kept constant during the reaction by metered addition of further carbon dioxide. The metered addition of one or more alkylene oxides is effected simultaneously, alternately or sequentially with the metered addition of carbon dioxide. It is possible to effect metered addition of the alkylene oxide at a constant metering rate or to increase or lower the metering rate gradually or stepwise or to add the alkylene oxide portionwise. The alkylene oxide is preferably added to the reaction mixture at a constant metering rate. If two or more alkylene oxides are used for synthesis of the polyether carbonate polyols the alkylene oxides may be metered in individually or as a mixture. The metered addition of the alkylene oxides can be effected simultaneously, alternately or sequentially, each via separate feeds (additions), or via one or more feeds, in which case the alkylene oxides can be metered in individually or as a mixture. It is possible via the manner and/or sequence of the metered addition of the alkylene oxides and/or of the carbon dioxide to synthesize random, alternating, block-type or gradient-type polyether carbonate polyols.

It is preferable to use an excess of carbon dioxide based on the calculated amount of carbon dioxide incorporated in the polyether carbonate polyol, since an excess of carbon dioxide is advantageous because of the inertness of carbon dioxide. The amount of carbon dioxide may be determined via the total pressure under the particular reaction conditions. An advantageous total pressure (absolute) for the copolymerization for preparing the polyether carbonate polyols has been found to be in the range from 0.01 to 120 bar, preferably 0.1 to 110 bar, more preferably from 1 to 100 bar. It is possible to feed in the carbon dioxide continuously or discontinuously. This depends on how quickly the alkylene oxides and the CO₂ are consumed and on whether the product is to include any CO₂-free polyether blocks or blocks having a different CO₂ content. The amount of the carbon dioxide (reported as pressure) can likewise vary in the course of addition of the alkylene oxides. Depending on the reaction conditions chosen the CO₂ may be introduced into the reactor in the gaseous, liquid or supercritical state. CO₂ can also be added to the reactor in solid form and then be converted to the gaseous, dissolved, liquid and/or supercritical state under the chosen reaction conditions.

In a process comprising metered addition of the H-functional starter substance in step (γ) the metered addition of the H-functional starter substance, of the alkylene oxide and optionally also of the carbon dioxide can be effected simultaneously or sequentially (portionwise); for example, it is possible to add the total amount of carbon dioxide, the amount of H-functional starter substance and/or the amount of alkylene oxide metered in in step (γ) all at once or continuously. The term “continuously” as used here can be defined as a mode of addition of a reactant such that a concentration of the reactant effective for the copolymerization is maintained, meaning that, for example, the metered addition may be carried out at a constant metered addition rate, at a varying metered addition rate or portionwise.

It is possible, during the addition of the alkylene oxide and/or of the H-functional starter substance, to increase or lower the CO₂ pressure gradually or stepwise or to leave it constant. The total pressure is preferably kept constant during the reaction by metered addition of further carbon dioxide. The metered addition of the alkylene oxide and/or of the H-functional starter substance is effected simultaneously or sequentially with respect to the metered addition of carbon dioxide. It is possible to effect metered addition of the alkylene oxide at a constant metering rate or to increase or lower the metering rate gradually or stepwise or to add the alkylene oxide portionwise. The alkylene oxide is preferably added to the reaction mixture at a constant metering rate. If two or more alkylene oxides are used for synthesis of the polyether carbonate polyols the alkylene oxides may be metered in individually or as a mixture. The metered addition of the alkylene oxides or the H-functional starter substances can be effected simultaneously or sequentially via separate feeds (additions) in each case or via one or more feeds, in which case the alkylene oxides or the H-functional starter substances can be metered in individually or as a mixture. It is possible via the manner and/or sequence of the metered addition of the H-functional starter substances, the alkylene oxides and/or the carbon dioxide to synthesize random, alternating, block or gradient polyether carbonate polyols.

In a preferred embodiment, in step (γ), the metered addition of the H-functional starter substance is ended at a juncture prior to the addition of the alkylene oxide.

A preferred embodiment of the process according to the invention is inter alia characterized in that in step (γ) the total amount of the H-functional starter substance is added, i.e. a suspension medium is employed in step (ca). This addition may be effected at a constant metered addition rate, at a varying metered addition rate or portionwise.

Preferably, the polyether carbonate polyols are prepared in a continuous process which comprises both a continuous copolymerization and a continuous addition of the H-functional starter substance. The invention therefore also provides a process wherein, in step (γ), H-functional starter substance, alkylene oxide and catalyst are continuously metered into the reactor in the presence of carbon dioxide (“copolymerization”) and wherein the resulting reaction mixture (containing the reaction product) is continuously removed from the reactor. It is preferable when in step (γ) the catalyst is continuously added in the form of a suspension in H-functional starter substance. The metered addition of the alkylene oxide, the H-functional starter substance and the catalyst may be effected via separate or common feed points. In a preferred embodiment, the alkylene oxide and the H-functional starter substance are continuously supplied to the reaction mixture via separate feed points. This addition of the H-functional starter substance can be effected in the form of a continuous metered addition to the reactor or portionwise.

For example, for the continuous process for preparing the polyether carbonate polyols in steps (α) and (β) an activated DMC catalyst/suspension medium mixture is prepared, then according to step (γ),
(γ1) a subamount each of H-functional starter substance, alkylene oxide and carbon dioxide are metered in to initiate the copolymerization, and
(γ2) during the progress of the copolymerization, the remaining amount of each of DMC catalyst, H-functional starter substance and alkylene oxide is metered in continuously in the presence of carbon dioxide, with simultaneous continuous removal of resulting reaction mixture from the reactor.

In step (γ) the catalyst is preferably added in the form of a suspension in the H-functional starter substance.

Steps (α), (β) and (γ) may be performed in the same reactor or may each be performed separately in different reactors. Particularly preferred reactor types are: tubular reactors, stirred tanks, loop reactors.

Steps (α), (β) and (γ) may be performed in a stirred tank, wherein depending on the embodiment and the operating mode the stirred tank is cooled via the reactor shell, internal cooling surfaces and/or cooling surfaces within a pumped circulation system. Both in the semi-batchwise process, in which the product is withdrawn only after the reaction has ended, and in the continuous process, in which the product is withdrawn continuously, particular attention should be paid to the metering rate of the alkylene oxide. Said rate should be adjusted such that despite the inhibiting effect of the carbon dioxide the alkylene oxides react sufficiently rapidly.

In a preferred embodiment, the mixture containing activated DMC catalyst that results from steps (α) and (β) is reacted further in the same reactor with alkylene oxide, H-functional starter substance and carbon dioxide. In a further preferred embodiment, the mixture containing activated DMC catalyst that results from steps (α) and (β) is reacted further with alkylene oxide, H-functional starter substance and carbon dioxide in another reaction vessel (for example a stirred tank, tubular reactor or loop reactor).

When conducting the reaction in a tubular reactor, the mixture containing activated DMC catalyst that results from the steps (α) and (β), H-functional starter substance, alkylene oxide and carbon dioxide are pumped continuously through a tube. The molar ratios of the coreactants vary according to the desired polymer. In a preferred embodiment, carbon dioxide is metered in in its liquid or supercritical form to achieve optimal miscibility of the components. It is advantageous to install mixing elements for better mixing of the co-reactants, such as are marketed for example by Ehrfeld Mikrotechnik BTS GmbH, or mixer-heat exchanger elements which simultaneously improve mixing and heat removal.

Loop reactors may likewise be used for performing steps (α), (β) and (γ). These generally include reactors with recycling, for example a jet loop reactor, which can also be operated continuously, or a loop-shaped tubular reactor with suitable apparatuses for circulation of the reaction mixture or a loop of a plurality of serially connected tubular reactors. The use of a loop reactor is advantageous particularly because backmixing may be realized here, so that the concentration of free alkylene oxides in the reaction mixture may be kept within the optimal range, preferably in the range from >0 to 40 wt %, more preferably >0 to 25 wt %, most preferably >0 to 15 wt % (in each case based on the weight of the reaction mixture).

It is preferable when steps (α) and (β) are performed in a first reactor, and the resulting reaction mixture is then transferred into a second reactor for the copolymerization of step (γ). However, it is also possible to perform steps (α), (β) and (γ) in one reactor.

The term “continuously” used here can be defined as the mode of addition of a relevant catalyst or reactant such that an essentially continuously effective concentration of the catalyst or the reactant is maintained. Catalyst feeding may be effected in a truly continuous manner or in relatively tightly spaced increments. Equally, continuous starter addition may be effected in a truly continuous manner or in increments. There would be no departure from the present process in adding a catalyst or reactants incrementally such that the concentration of the materials added drops essentially to zero for a period of time before the next incremental addition. However, it is preferable for the catalyst concentration to be kept substantially at the same concentration during the main portion of the course of the continuous reaction, and for starter substance to be present during the main portion of the copolymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

Step (δ)

In an optional step (δ) the reaction mixture continuously removed in step (γ) which generally has an alkylene oxide content of from 0.05% by weight to 10% by weight may be transferred into a postreactor in which, by way of a postreaction, the content of free alkylene oxide is reduced to less than 0.05% by weight in the reaction mixture. The postreactor may be a tubular reactor, a loop reactor or a stirred tank for example. The pressure in this postreactor is preferably at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 50° C. to 150° C. and more preferably 80° C. to 140° C.

The polyether carbonate polyols obtained in accordance with the invention have a functionality, for example, of at least 1, preferably of 1 to 8, more preferably of 1 to 6 and most preferably of 2 to 4. The molecular weight is preferably 400 to 10 000 g/mol and more preferably 500 to 6000 g/mol.

The content of volatile constituents in the polyether carbonate polyol resulting from step (i) may be thermally reduced at a temperature of 80° C. to 200° C. prior to step (ii) and/or the content of volatile constituents in the reaction mixture from step (ii) may be reduced by thermal means at a temperature of 80° C. to 200° C.

Thermal reduction of the volatile constituents may be accomplished using the methods that are common knowledge to those skilled in the art from the prior art. For example, the thermal reduction of the volatile constituents can be achieved by thin-film evaporation, short-path evaporation or falling-film evaporation, which is preferably effected under reduced pressure (vacuum). In addition, it is also possible to use conventional distillation processes in which the polyether carbonate polyol is heated to a temperature of 80° C. to 200° C. in a flask or a stirred tank for example and the volatile constituents are distilled off overhead. The efficiency of the distillation can be enhanced by employing reduced pressure and/or an inert stripping gas (for example nitrogen) and/or an entraining agent (for example water or inert organic solvent). In addition, the reduction of the volatile constituents can also be achieved by vacuum stripping in a packed column, where steam or nitrogen are typically used as the stripping gas.

DMC Catalyst:

The process according to the invention preferably employs a DMC catalyst.

DMC catalysts for use in the homopolymerization of alkylene oxides are known in principle from the prior art (see, for example, U.S. Pat. Nos. 3,404,109, 3,829,505, 3,941,849 and U.S. Pat. No. 5,158,922). DMC catalysts, as described for example in U.S. Pat. No. 5,470,813, EP-A 700 949, EP-A 743 093, EP-A 761 708, WO 97/40086, WO 98/16310 and WO 00/47649, have a very high activity and enable the preparation of polyether carbonate polyols at very low catalyst concentrations so that a removal of the catalyst from the finished product is generally no longer required. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by
(i) reacting an aqueous solution of a metal salt with the aqueous solution of a metal cyanide salt in the presence of one or more organic complex ligands, e.g. an ether or alcohol, in a first step,
(ii) separating the solid from the suspension obtained from (i) by known techniques (such as centrifugation or filtration) in a second step,
(iii) optionally washing the isolated solid with an aqueous solution of an organic complex ligand (for example by resuspending and subsequent reisolating by filtration or centrifugation) in a third step,
(iv) and subsequently drying the solid obtained at temperatures of in general 20-120° C. and at pressures of in general 0.1 mbar to atmospheric pressure (1013 mbar), optionally after pulverizing, wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess, based on zinc hexacyanocobaltate) is added to the suspension formed.

Metal salts suitable for preparation of the double metal cyanide compounds preferably have the general formula (II)

M(X)ₙ (II)

wherein

M is selected from the metal cations Zn²⁺, Fe²⁺, Ni²⁺, Mn²⁺, CO²⁺, Sr²⁺, Sn²⁺, Pb²⁺ and Cu²⁺; M is preferably Zn²⁺, Fe²⁺, CO₂⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

wherein

M is selected from the metal cations Fe³⁺, Al₃⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

wherein

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)t (V)

wherein

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐ M′(CN)_{b}(A)_{c} (VI)

wherein

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Lie, Na⁺, K⁺, Rb⁺) and alkaline earth metal (i.e. Be²⁺, Mg2+, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ,(CN)_{y}]_{z} (VII)

where M is as defined in formula (II) to (V) and

M′ is as defined in formula (VI), and

x, x′, y and z are integers and are selected such as to ensure the electroneutrality of the double metal cyanide compound.

It is preferable when

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms, such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). Most preferred organic complex ligands are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acid or the salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. The complex-forming component is preferably employed in a mixture with water and organic complex ligand. A preferred process for performing the first step (i.e. the preparation of the suspension) is effected using a mixing nozzle, particularly preferably using a jet disperser, as described in WO-A 01/39883.

In the second step, the solid (i.e. the precursor of the catalyst of the invention) is isolated from the suspension by known techniques, such as centrifugation or filtration.

In a preferred embodiment variant, the isolated solid is subsequently washed in a third process step with an aqueous solution of the organic complex ligand (for example by resuspension and subsequent reisolation by filtration or centrifugation). Water-soluble by-products for example, such as potassium chloride, can be removed from the catalyst in this way. The amount of the organic complex ligand in the aqueous wash solution is preferably between 40% and 80% by weight, based on the overall solution.

A further complex-forming component is optionally added to the aqueous wash solution in the third step, preferably in the range between 0.5% and 5% by weight, based on the overall solution.

It is also advantageous to wash the isolated solid more than once. It is preferable when said solids are washed with an aqueous solution of the organic complex ligand (for example with an aqueous solution of the unsaturated alcohol) in a first washing step (iii-1) (for example by resuspension and subsequent reisolation by filtration or centrifugation), in order thus to remove, for example, water-soluble by-products such as potassium chloride from the catalyst. It is particularly preferable when the amount of the organic complex ligand (for example unsaturated alcohol) in the aqueous wash solution is between 40% and 80% by weight based on the overall solution for the first washing step. In the further washing steps (iii-2), either the first washing step is repeated one or more times, preferably one to three times, or, preferably, a nonaqueous solution, for example a mixture or solution of organic complex ligands (for example unsaturated alcohol) and further complex-forming component (preferably in the range between 0.5% and 5% by weight, based on the total amount of the wash solution in step (iii-2)), is used as a washing solution, and the solid is washed with it one or more times, preferably one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts from the suspension by filtration, filtercake washing and drying is described in WO-A 01/80994.

In addition to the preferably employed DMC catalysts based on zinc hexacyanocobaltate (Zn₃[Co(CN)₆]₂) the process according to the invention may also employ other metal complex catalysts based on the metals zinc and/or cobalt and familiar to those skilled in the art from the prior art for the copolymerization of epoxides and carbon dioxide. This especially includes what are called zinc glutarate catalysts (described, for example, in M. H. Chisholm et al., Macromolecules 2002, 35, 6494), what are called zinc diiminate catalysts (described, for example, in S. D. Allen, J. Am. Chem. Soc. 2002, 124, 14284), what are called cobalt salen catalysts (described, for example, in U.S. Pat. No. 7,304,172 B2, US 2012/0165549 A1), and bimetallic zinc complexes having macrocyclic ligands (described, for example, in M. R. Kember et al., Angew. Chem., Int. Ed., 2009, 48, 931).

After performance of the process of the invention for preparing the polyether carbonate polyol, the resulting reaction mixture generally comprises the DMC catalyst in the form of finely dispersed solid particles. It may therefore be desirable to remove the DMC catalyst as completely as possible from the resulting reaction mixture. The removal of the DMC catalyst firstly has the advantage that the resulting polyether carbonate polyol achieves industry- or certification-relevant limits for example in terms of metal contents or in terms of other emissions resulting from activated catalyst remaining in the product and also facilitates recovery of the DMC catalyst.

The DMC catalyst may be removed very substantially or completely using various methods. The DMC catalyst can be separated from the polyether carbonate polyol, for example, using membrane filtration (nanofiltration, ultrafiltration or crossflow filtration), using cake filtration, using precoat filtration or by centrifugation.

Preferably, removal of the DMC catalyst is accomplished by a multistage process consisting of at least two steps.

For example, in a first step, the reaction mixture to be filtered is divided in a first filtration step into a larger substream (filtrate) in which a majority of the catalyst or all the catalyst has been removed, and a smaller residual stream (retentate) comprising the removed catalyst. In a second step, the residual stream is then subjected to a dead end filtration. This affords a further filtrate stream in which a majority of the catalyst or all the catalyst has been removed, and a damp to very substantially dry catalyst residue.

Alternatively, the catalyst present in the polyether carbonate polyol can be subjected in a first step to an adsorption, agglomeration/coagulation and/or flocculation, followed by, in a second step or a plurality of subsequent steps, the separation of the solid phase from the polyether carbonate polyol. Suitable adsorbents for mechanical-physical and/or chemical adsorption include activated or non-activated aluminas and bleaching earths (sepiolite, montmorillonite, talc etc.), synthetic silicates, activated carbon, siliceous earths/kieselguhrs and activated siliceous earths/kieselguhrs in amounts typically ranging from 0.1% by weight to 2% by weight, preferably 0.8% by weight to 1.2% by weight, based on the polyether carbonate polyol, at temperatures of from 60° C. to 140° C., preferably 90° C. to 110° C., and with dwell times of 20 min to 100 min, preferably 40 min to 80 min, it being possible to conduct the adsorption step, including the mixing-in of the adsorbent, in batchwise or continuous mode.

A preferred process for removing this solid phase (consisting, for example, of adsorbent and DMC catalyst) from the polyether carbonate polyol is precoat filtration. Here, depending on the filtration behavior which is determined by the particle size distribution of the solid phase to be removed, the average specific resistance of the resulting filtercake and the total resistance of the precoat layer and filtercake, the filter surface is coated with a permeable filtration aid (for example inorganic: celite, perlite; organic: cellulose) with a layer thickness of from 20 mm to 250 mm, preferably 100 mm to 200 mm (“pre-coat”). The majority of the solid phase (consisting, for example, of adsorbent and DMC catalyst) is removed at the surface of the precoat layer in combination with depth filtration of the smaller particles within the precoat layer. The temperature of the crude product to be filtered is in the range from 50° C. to 120° C., preferably 70° C. to 100° C.

In order to ensure a sufficient flow of product through the precoat layer and the cake layer growing thereon, the cake layer and a small part of the precoat layer may be removed (periodically or continuously) using a scraper or blade and removed from the process. This scraper/blade is moved at minimal advance rates of about 20 μm/min-500 μm/min, preferably in the range of 50 μm/min-150 μm/min.

As soon as the precoat layer has been very substantially or completely removed by this process, the filtration is stopped and a new precoat layer is applied to the filter surface. In this case, the filtration aid may be suspended, for example, in cyclic propylene carbonate.

This precoat filtration is typically conducted in vacuum drum filters. In order to achieve industrially relevant filtrate throughputs in the range from 0.1 m³/(m²·h) to 5 m³/(m²·h) in the case of a viscous feed stream, the drum filter may also be executed as a pressure drum filter with pressure differentials of up to 6 bar and more between the medium to be filtered and the filtrate side.

In principle, the DMC catalyst may be removed from the resulting reaction mixture in the process of the invention either before removal of volatile constituents (for example cyclic propylene carbonate) or after the removal of volatile constituents.

In addition, the separation of the DMC catalyst from the resulting reaction mixture from the process of the invention may be conducted with or without the further addition of a solvent (especially cyclic propylene carbonate) for the purpose of lowering the viscosity before or during the individual steps of catalyst removal described.

The polyether carbonate polyols obtainable by the process according to the invention have a low content of by-products and are readily processable, especially by reaction with di- and/or polyisocyanates to afford polyurethanes, in particular flexible polyurethane foams.

In addition, the polyether carbonate polyols obtainable by the process of the invention can be used in applications such as washing and cleaning composition formulations, drilling fluids, fuel additives, ionic and nonionic surfactants, lubricants, process chemicals for papermaking or textile manufacture, or cosmetic formulations.

In a first embodiment, the invention relates to a process for preparing polyether carbonate polyols by the steps of
(i) addition reaction of alkylene oxide and carbon dioxide onto an H-functional starter substance in the presence of a double metal cyanide catalyst or a metal complex catalyst based on the metals zinc and/or cobalt to obtain a reaction mixture containing the polyether carbonate polyol,
(ii) addition of at least one component K to the reaction mixture containing the polyether carbonate polyol, characterized in that as component K a buffer system suitable for buffering a pH in the range from pH 3.0 to PH 9.0 is employed, wherein component K is free from compounds containing P—OH groups.

In a second embodiment, the invention relates to a process according to the first embodiment, characterized in that component K contains neither compounds containing a phosphorus-oxygen bond nor compounds of phosphorus capable of forming one or more P—O bonds by reaction with OH-functional compounds.

In a third embodiment, the invention relates to a process according to either of embodiments 1 or 2, characterized in that the content of volatile constituents in the polyether carbonate polyol resulting from step (i) is thermally reduced at a temperature of 80° C. to 200° C. prior to step (ii).

In a fourth embodiment, the invention relates to a process according to any of embodiments 1 to 3, characterized in that
(iii) the content of volatile constituents in the reaction mixture from step (ii) is thermally reduced at a temperature of 80° C. to 200° C.

In a fifth embodiment, the invention relates to a process according to the fourth embodiment, characterized in that
(iv) at least one component K is added to the reaction mixture containing the polyether carbonate polyol from step (iii).

In a sixth embodiment, the invention relates to a process according to the fifth embodiment, characterized in that in step (iv) component K is added in an amount of 5 ppm to 2000 ppm, preferably 10 ppm to 1000 ppm and more preferably 30 to 500 ppm.

In a seventh embodiment, the invention relates to a process according to any of embodiments 1 to 6, characterized in that in step (ii) component K in an amount of 5 ppm to 2000 ppm, preferably 10 ppm to 1000 ppm, more preferably 30 ppm to 500 ppm.

In an eighth embodiment, the invention relates to a process according to any of embodiments 1 to 7, characterized in that the buffer system is suitable for buffering a pH in the range from pH 3.0 to pH 7.5.

In a ninth embodiment, the invention relates to a process according to any of embodiments 1 to 7, characterized in that as component K at least one buffer system selected from the group consisting of mixtures of carboxylic acids and alkali metal salts thereof, aqueous solutions of alkali metal salts of carboxylic acids, MES and HEPPS is employed.

In a tenth embodiment, the invention relates to a process according to any of embodiments 1 to 7, characterized in that as component K at least one buffer system selected from the group consisting of malic acid/Na salt of malic acid, MES and HEPPS is employed.

In an eleventh embodiment, the invention relates to a process according to any of embodiments 1 to 10, characterized in that in step (i)
(α) an H-functional starter substance or a mixture of at least two H-functional starter substances or a suspension medium is initially charged and optionally water and/or other volatile compounds are removed by elevated temperature and/or reduced pressure (“drying”), wherein the catalyst is added to the H-functional starter substance or to the mixture of at least two H-functional starter substances or the suspension medium before or after the drying,
(β) optionally for activation of the DMC catalyst a subamount (based on the total amount of alkylene oxides employed in the activation and copolymerization) of alkylene oxide is added to the mixture resulting from step (α), wherein this addition of a subamount of alkylene oxide may optionally be carried out in the presence of CO₂ and wherein the temperature spike (“hotspot”) occurring on account of the subsequent exothermic chemical reaction and/or a pressure drop in the reactor is then awaited in each case and wherein step (β) for activation may also be carried out two or more times,
(γ) alkylene oxide, carbon dioxide and optionally an H-functional starter substance are added to the mixture resulting from step (β),

wherein at least one H-functional starter substance is added in at least one of steps (α) or (γ).

In a twelfth embodiment, the invention relates to a process according to the eleventh embodiment, characterized in that the reaction mixture resulting from step (γ) is removed from the reactor.

In a thirteenth embodiment, the invention relates to a process according to embodiment 11 or 12, characterized in that in step (γ) DMC catalyst is continuously metered into the reactor.

In a fourteenth embodiment the invention relates to a mixture containing polyether carbonate polyol and component K, characterized in that as component K a buffer system suitable for buffering a pH in the range from pH 3.0 to PH 9.0 is employed, wherein component K is free from compounds containing P—OH groups.

In a fifteenth embodiment, the invention relates to a mixture according to the fourteenth embodiment, characterized in that as component K at least one buffer system selected from the group consisting of mixtures of carboxylic acids and alkali metal salts thereof, aqueous solutions of alkali metal salts of carboxylic acids, MES and HEPPS is employed.

In a sixteenth embodiment, the invention relates to a mixture according to the fourteenth embodiment, characterized in that as component K at least one buffer system selected from the group consisting of malic acid/Na salt of malic acid, MES and HEPPS is employed.

### Examples

Methods:

OH Number:

The OH numbers (hydroxyl numbers) were determined in accordance with the specification of DIN 53240-2 (November 2007).

Viscosity:

Viscosity was determined on an Anton Paar Physica MCR 501 rheometer. A cone-plate configuration having a separation of 1 mm was selected (DCP25 measurement system). The polyether carbonate polyol (0.1 g) was applied to the rheometer plate and subjected to a shear of 0.01 to 1000 l/s at 25° C. and the viscosity was measured every 10 s for 10 min. What is reported is the viscosity averaged over all measurement points.

GPC:

The number-average Mₙ and the weight-average M_{w} of the molecular weight and the polydispersity (M_{w}/Mₙ) of the products was determined by gel permeation chromatography (GPC). The procedure of DIN 55672-1 was followed (March 2016): “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass were used for calibration.

CO₂ Content in the Polyether Carbonate Polyol:

The proportion of incorporated CO₂ in the resulting polyether carbonate polyol and the ratio of propylene carbonate to polyether carbonate polyol were determined by ¹H-NMR (Bruker DPX 400, 400 MHz; pulse programme zg30, d1 relaxation delay: 10 s, 64 scans). Each sample was dissolved in deuterated chloroform. The relevant resonances in the ¹H NMR (based on TMS=0 ppm) are as follows:

Cyclic carbonate (which was formed as a by-product) having a resonance at 4.5 ppm, carbonate resulting from carbon dioxide incorporated in the polyether carbonate polyol having resonances at 5.1 to 4.8 ppm, unreacted PO having a resonance at 2.4 ppm, polyether polyol (i.e. without incorporated carbon dioxide) having resonances at 1.2 to 1.0 ppm, the octane-1,8-diol incorporated as starter molecule (if present) having a resonance at 1.6 to 1.52 ppm.

The mole fraction of the carbonate incorporated in the polymer in the reaction mixture is calculated by formula (VIII) as follows using the following abbreviations:
A(4.5)=area of the resonance at 4.5 ppm for cyclic carbonate (corresponds to one hydrogen atom)
A(5.1-4.8)=area of the resonance at 5.1-4.8 ppm for polyether carbonate polyol and one hydrogen atom for cyclic carbonate
A(2.4)=area of the resonance at 2.4 ppm for free, unreacted PO
A(1.2-1.0)=area of the resonance at 1.2-1.0 ppm for polyether polyol
A(1.6-1.52)=area of the resonance at 1.6 to 1.52 ppm for octane-1,8-diol (starter), if present.

Taking account of the relative intensities, the values for the polymer-bound carbonate (“linear carbonate” LC) in the reaction mixture were converted to mol % as per the following formula (VIII):

$$LC = \frac{A ( 5.1 - 4.8 ) - A ( 4.5 )}{\begin{matrix}A ( 5.1 - 4.8 ) + A ( 2.4 ) + 0.33 ⋆ \\ A ( 1.2 - 1. ) + 0.25 ⋆ A ( 1.6 - 1.52 )\end{matrix}} * 100 \qquad ( VIII )$$

The weight fraction (in % by weight) of polymer-bonded carbonate (LC′) in the reaction mixture was calculated by formula (IX),

$$L {C}^{′} = \frac{[ A ( 5.1 - 4.8 ) - A ( 4.5 ) ] ⋆ 102}{D} ⋆ 100 \% \qquad ( IX )$$

where the value of D (“denominator” D) is calculated by formula (X):

D=[A(5.1−4.8)−A(4.5)]*102+A(4.5)*102+A(2.4)*58+0.33*A(1.2−1.0)*58+0.25*A(1.6−1.52)*146 (X)

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC′) in the reaction mixture was calculated by formula (XI),

$$C {C}^{′} = \frac{A ( 4.5 ) * 102}{D} * 100 \% \qquad ( XI )$$

where the value of D is calculated by formula (X).

In order to calculate the composition based on the polymer component (consisting of polyether polyol built up from starter and propylene oxide during the activation steps taking place under CO₂-free conditions, and polyether carbonate polyol built up from starter, propylene oxide and carbon dioxide during the activation steps taking place in the presence of CO₂ and during the copolymerization) from the values for the composition of the reaction mixture, the nonpolymeric constituents of the reaction mixture (i.e. cyclic propylene carbonate and any unreacted propylene oxide present) were eliminated mathematically. The proportion by weight of the repeat carbonate units in the polyether carbonate polyol was converted to a proportion by weight of carbon dioxide using the factor A=44/(44+58). The value for the CO₂ content in the polyether carbonate polyol is normalized to the proportion of the polyether carbonate polyol molecule which was formed in the copolymerization and in any activation steps in the presence of CO₂ (i.e. the proportion of the polyether carbonate polyol molecule resulting from the starter (octane-1,8-diol, if present) and from the reaction of the starter with epoxide which was added under CO₂-free conditions was not taken into account here). The CO₂ content, the hydroxyl number and the employed starter were used in each case to calculate the e/f ratio (see formula (Ia)) for the respective polyether carbonate polyol.

Production of Polyether Carbonate Polyol A

A continuously operated 60 L pressure reactor with gas metering unit and product discharge tube was initially charged with 32.9 L of a polyether carbonate polyol (OH functionality=2.8; OH number=56 mg KOH/g; CO₂ content=20% by weight) containing 200 ppm of DMC catalyst (produced according to WO 01/80994 A1, example 6 therein). At a temperature of 108° C. and a total pressure of 63.5 bar (absolute), the following components were metered at the metering rates specified while stirring (11 Hz):
propylene oxide at 6.7 kg/h
carbon dioxide at 2.4 kg/h
mixture of glycerol/propylene glycol (85% by weight/15% by weight) containing 0.69% by weight of DMC catalyst (unactivated) and 146 ppm (based on the mixture of glycerol, propylene glycol and DMC catalyst) of H₃PO₄ (used in the form of an 85% aqueous solution) at 0.26 kg/h.

The reaction mixture was withdrawn continuously from the pressure reactor via the product discharge tube, such that the reaction volume (32.9 L) was kept constant, with a mean dwell time of the reaction mixture in the reactor of 200 min.

To complete the reaction, the reaction mixture withdrawn was transferred into a postreactor (tubular reactor having a reaction volume of 2.0 L) which had been heated to 119° C. The average residence time of the reaction mixture in the postreactor was 12 min. The product was then decompressed to atmospheric pressure and then 500 ppm of antioxidant Irganox® 1076 were added.

The product was then brought to a temperature of 120° C. using a heat exchanger and immediately thereafter transferred to a 332 L tank and kept at a temperature of at least 112° C. for a residence time of 4 hours.

Finally, the product, for removal of the cyclic propylene carbonate, was subjected to a two-stage thermal workup, namely in a first stage by means of a falling-film evaporator, followed, in a second stage, by a stripping column operated in a nitrogen countercurrent.

The falling-film evaporator was operated here at a temperature of 169° C. and a pressure of 17 mbar (absolute). The falling-film evaporator used consisted of glass with an exchange area of 0.5 m². The apparatus had an externally heated tube with a diameter of 115 mm and a length of about 1500 mm. The nitrogen stripping column was operated at a temperature of 160° C., a pressure of 80 mbar (absolute) and a nitrogen flow rate of 0.6 kg N₂/kg product. The stripping column used was a DN80 glass column filled to a height of 8 m with random packings (Raschig #0.3 Super-Rings).

The resulting polyether carbonate polyol A was subjected to analytical examination and the following results were obtained:

cPC content=55 ppm

CO₂ content=18.4%

To determine thermal stability, the polyether carbonate polyol A was stored with and without the addition of a component K for 2 hours at 160° C. In the examples component K was employed as an aqueous solution containing 1% by weight of component K. The cPC contents obtained after thermal stress are summarized in Table 1.

TABLE 1

| | | Proportion of | |
|---|---|---|---|
| Example | Component K | component K in ppm | cPC content in ppm |
| 1* | — | — | 172 |
| 2* | H₃PO₄/KH₂PO₄ | 200 | 83 |
| 3 | Malic acid/Na salt | 200 | 38 |
| | of malic acid | | |
| 4 | MES | 200 | 55 |
| 5 | HEPPS | 200 | 57 |
| 6* | K₂CO₃/KHCO₃ | 200 | 3033 |

*comparative example

1. A process for preparing polyether carbonate polyols by the steps of:
(i) performing an addition reaction of alkylene oxide and carbon dioxide onto an H-functional starter substance in the presence of a double metal cyanide catalyst or a metal complex catalyst based on the metals zinc and/or cobalt to obtain a reaction mixture containing the polyether carbonate polyol, and
(ii) adding at least one component K to the reaction mixture containing the polyether carbonate polyol,
wherein the at least one component K comprises a buffer system suitable for buffering a pH in the range from pH 3.0 to pH 9.0, and wherein the at least one component K is free from compounds containing P—OH groups.

2. The process as claimed in claim 1, wherein the at least one component K is free from compounds containing a phosphorus-oxygen bond and compounds of phosphorus capable of forming one or more P—O bonds by reaction with OH-functional compounds.

3. The process as claimed in claim 1, wherein the content of volatile constituents in the polyether carbonate polyol resulting from step (i) is thermally reduced at a temperature of 80° C. to 200° C. prior to step (ii).

4. The process as claimed in claim 1, wherein:
(iii) the content of volatile constituents in the reaction mixture from step (ii) is thermally reduced at a temperature of 80° C. to 200° C.

5. The process as claimed in claim 4, wherein:
(iv) the at least one component K is added to the reaction mixture containing the polyether carbonate polyol from step (iii).

6. The process as claimed in claim 5, wherein the at least one component K is added in step (iv) in an amount of 5 ppm to 2000 ppm.

7. The process as claimed in claim 1, wherein the at least one component K is added in step (ii) in an amount of 5 ppm to 2000 ppm.

8. The process as claimed in claim 1, wherein the buffer system is suitable for buffering a pH in the range from pH 3.0 to pH 7.5.

9. The process as claimed in claim 1, wherein the at least one component K is at least one buffer system selected from the group consisting of mixtures of carboxylic acids and alkali metal salts thereof, aqueous solutions of alkali metal salts of carboxylic acids, MES and HEPPS.

10. The process as claimed in claim 1, wherein the at least one component K is at least one buffer system selected from the group consisting of malic acid/Na salt of malic acid, MES and HEPPS.

11. The process as claimed in claim 1, wherein in step (i)
(α) an H-functional starter substance or a mixture of at least two H-functional starter substances or a suspension medium is initially charged, wherein the catalyst is added to the H-functional starter substance or to the mixture of at least two H-functional starter substances or the suspension medium before or after the drying,

12. The process as claimed in claim 17, wherein the reaction mixture resulting from step (7) is removed from the reactor.

13. The process as claimed in claim 17, wherein in step (γ) DMC catalyst is continuously metered into the reactor.

14. A mixture containing polyether carbonate polyol and a component K, wherein the component K comprises a buffer system suitable for buffering a pH in the range from pH 3.0 to pH 9.0, wherein the component K is free from compounds containing P—OH groups.

15. The mixture as claimed in claim 14, wherein the component K is at least one buffer system selected from the group consisting of mixtures of carboxylic acids and alkali metal salts thereof, aqueous solutions of alkali metal salts of carboxylic acids, MES and HEPPS.

16. The process as claimed in claim 11, wherein in step (i)
(α) an H-functional starter substance or a mixture of at least two H-functional starter substances or a suspension medium is initially charged and water and/or other volatile compounds are removed by a drying at elevated temperature and/or reduced pressure, wherein the catalyst is added to the H-functional starter substance or to the mixture of at least two H-functional starter substances or the suspension medium before or after the drying.

17. The process as claimed in claim 11, wherein in step (i)
(β) for activation of the DMC catalyst, a subamount, based on the total amount of alkylene oxides employed in the activation and copolymerization, of alkylene oxide is added to the mixture resulting from step (α), wherein the temperature spike occurring on account of the subsequent exothermic chemical reaction and/or a pressure drop in the reactor is then awaited in each case and wherein step (β) for activation may also be carried out two or more times, and
(γ) alkylene oxide and carbon dioxide are added to the mixture resulting from step (β).

18. The process as claimed in claim 17, wherein in step (β) a subamount of alkylene oxide is added to the mixture resulting from step (α) is carried out in the presence of CO₂.

19. The process as claimed in claim 17, wherein in step (γ) alkylene oxide, carbon dioxide and an H-functional starter substance are added to the mixture resulting from step (β).

20. The process as claimed in claim 6, wherein a component K is added in step (iv) in an amount of 30 to 500 ppm.
